(19) United States
(12) Patent Application Publication
(10) Pub. No.: US 2017/0202264 A1
(43) Pub. Date: Jul. 20, 2017

(54) PERSONAL CIGARETTE DISPENSING RECEPTACLE WITH TIME LOCK

(71) Applicant: Zbigniew Makarewicz, Plainfield, IL (US)

(72) Inventor: Zbigniew Makarewicz, Plainfield, IL (US)

(21) Appl. No.: 14/997,183

(22) Filed: Jan. 15, 2016

(51) Int. Cl. A24F 15/00; G04F 10/00

(52) U.S. Cl. CPC A24F 15/005; G04F 10/00

(57) ABSTRACT

A personal cigarette dispensing receptacle for mechanically limiting ones access to their cigarettes includes a receptacle base having a receptacle top sized to fit thereon so as to form a cigarette enclosure. Integral with the receptacle base is an electronics housing electronics housing is operative to control a locking mechanism and an audible alarm on selectable time intervals. The locking mechanism includes an electromagnet integrated with the receptacle base and a ferromagnetic surface integrated with the receptacle top such that the receptacle top may be selectively fixed in place on the receptacle base. Through this action, the receptacle top may be locked in place for a closed time period, opened briefly for an open time period to allow a user to remove a cigarette, and then be automatically locked again to prevent access to another cigarette until the expiration of the closed time period.

### BACKGROUND OF THE INVENTION

Field of the Invention

This invention relates generally to storage devices and, more particularly, to a personal storage receptacle with an integrated time lock for holding and dispensing cigarettes.

Description of the Prior Art

There have been many attempts to enable an individual to limit their consumption of cigarettes over the course of a day or other set time frame. Chemical interventions, such as gums and patches, are operative to reduce ones craving for a cigarette on demand by delivering nicotine to a user's bloodstream through an alternate avenue. But for individuals who also wish to reduce their dependency on nicotine, such chemical interventions may be counterproductive.

Thus, there remains a need for a personal cigarette dispensing receptacle for holding and dispensing cigarettes which would allow a user to mechanically limit their access to a cigarette. It would be helpful if such a personal cigarette dispensing receptacle included an integrated time lock which enabled the receptacle to be opened only on scheduled intervals. It would be additionally desirable for such a personal cigarette dispensing receptacle included an alarm system operative to remind the user if the receptacle is not closed within a selected time period once it is opened.

The Applicant's invention described herein provides for a personal cigarette dispensing receptacle adapted to allow a user to generate limit how often a cigarette can be retrieved therefrom. The primary components in Applicant's personal cigarette dispensing receptacle are a receptacle base, receptacle top, and electromagnetic locking mechanism. When in operation, the personal cigarette dispensing receptacle provides a non-chemical intervention method to help a user limit the consumption of cigarettes. As a result, many of the limitations imposed by prior art mechanisms are removed.

### SUMMARY OF THE INVENTION

A personal cigarette dispensing receptacle for mechanically limiting ones access to their cigarettes. The personal cigarette dispensing receptacle comprises a rigid receptacle base having a rigid, hinged receptacle top sized to fit thereon so as to form an enclosure sized to fit up to 20 cigarettes. Integral with the receptacle base is an electronics housing, an electrical port, and a speaker. The electronics housing, which includes a controller and battery, is operative to enable a time intervals to be tracked as well as to control a locking mechanism and an audible alarm. The locking mechanism includes an electromagnet integrated with the receptacle base and a ferromagnetic surface integrated with the receptacle top such that the receptacle top may be selectively fixed in place on the receptacle base when an electrical current is passed through the electromagnet when the receptacle top is positioned on the receptacle base. Through this action, the receptacle top may be locked in place for a closed time period, opened briefly for an open time period to allow a user to remove a cigarette, and then be automatically locked again to prevent access to another cigarette until the expiration of the closed time period.

It is an object of this invention to provide a personal cigarette dispensing receptacle for holding and dispensing cigarettes which would allow a user to mechanically limit their access to a cigarette.

It is another object of this invention to provide a personal cigarette dispensing receptacle which includes an integrated time lock which enabled the receptacle to be opened only on scheduled intervals.

It is yet another object of this invention to provide a personal cigarette dispensing receptacle which includes an alarm system operative to remind the user if the receptacle is not closed within a selected time period once it is opened.

These and other objects will be apparent to one of skill in the art.

### BRIEF DESCRIPTION OF THE DRAWINGS

FIG. 1 is a front perspective view of a personal cigarette dispensing receptacle built in accordance with the present invention in a closed configuration.

FIG. 2 is a bottom plan view of a personal cigarette dispensing receptacle built in accordance with the present invention.

FIG. 3 is a side elevational view of a personal cigarette dispensing receptacle built in accordance with the present invention in a closed configuration.

FIG. 4 is a side elevational view of a personal cigarette dispensing receptacle built in accordance with the present invention in an open configuration.

FIG. 5 is an exploded front perspective view of a personal cigarette dispensing receptacle built in accordance with the present invention in an open configuration.

### DETAILED DESCRIPTION OF THE INVENTION

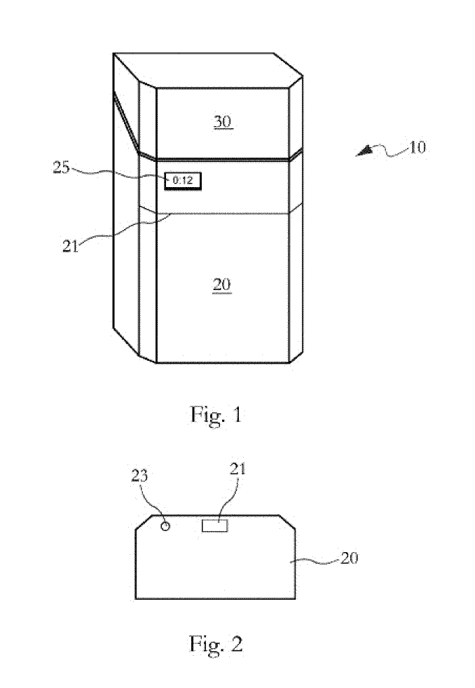

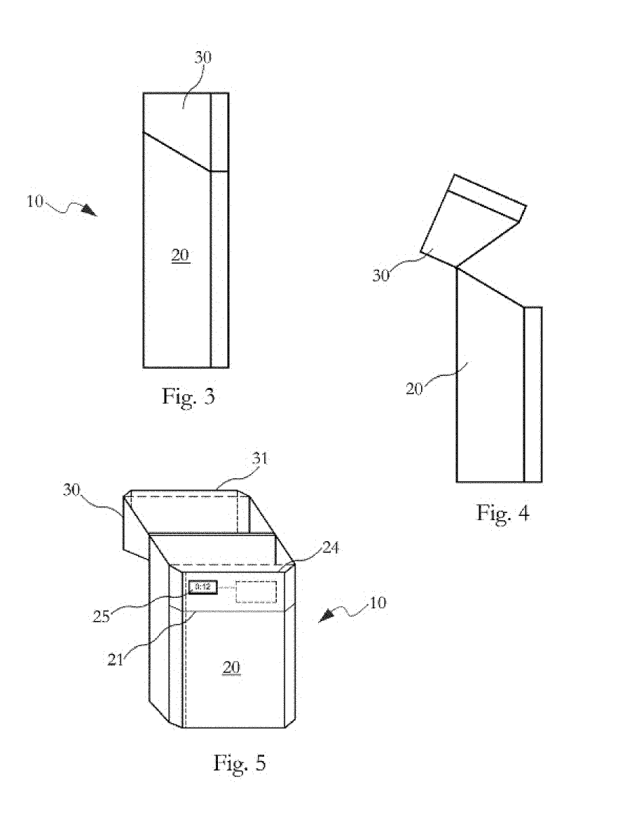

Referring now to the drawings and in particular FIGS. 1, 2, 3, 4 and 5, a personal cigarette dispensing receptacle 10 is shown as a rigid receptacle base 20 that includes a rigid, receptacle top 30 hingedly attached thereto. When the personal cigarette dispensing receptacle 10 is in a closed configuration, defined by the receptacle top 30 is in place on the receptacle base 20, they combine to form an enclosure which measures 3.5 inches tall, 2.25 inches wide, and 1 inch deep in the preferred embodiment. In some embodiments, all or a part of the exterior walls which defend the enclosure formed by the receptacle base 20 and/or the receptacle top 30 may be transparent.

Integral with the receptacle base 20 is an electronics housing 21, an electrical port 22, and a speaker 23. The electronics housing 21, which includes a controller and battery, is operative to enable a time intervals to be tracked as well as to control an electromagnetic locking mechanism and an audible alarm. As such, it is contemplated that the controller includes a conventional timer software which allows it to track selected time periods and is electrically connected to the electrical port 22, battery, locking mechanism and the speaker 23. Through such connections, the controller can facilitate the charging of the battery with electricity availed through the electrical port 22, the selective provision of electricity from the battery or electrical port 22 to the locking mechanism (as detailed below), and the transmission of an electrical signal to the speaker 23 to allow the broadcast of an audible alert therethrough.

In the preferred embodiment, the locking mechanism includes an electromagnet 24 integrated with the receptacle base 20 and a ferromagnetic surface 31 integrated with the receptacle top 30, each positioned such that when personal cigarette dispensing receptacle 10 is in the closed configuration, ferromagnetic surface 31 is adjacent to the electromagnet 24. As such, the receptacle top 30 may be selectively fixed to the receptacle base 20 when an electrical current is passed through the electromagnet 24 when the personal cigarette dispensing receptacle 10 is in the closed configuration (with the ferromagnetic surface 31 adjacent to the electromagnet 24) and be hingedly movable therefrom when no current is passed through the electromagnet 24.

In operation, it is contemplated that the controller will be set to count down from a selected time interval (a closed time period, which may be, for example, one hour) and keep the receptacle top 30 fixed in place while doing so. Then, once the time interval expires, the controller will interrupt the current to the electromagnet 24 for a selected time interval (an open time period, which may be, for example, 30 seconds) and reintroduce the current to the electromagnet 24 to again lock the receptacle top in place.

In one embodiment, upon the expiration of the open time period, the controller causes the speaker 23 to emit an audible alarm to alert a user to replace the receptacle top 30.

In some embodiments, the receptacle base 20 includes a sensor operative to determine whether the receptacle top 30 is in place on the receptacle base 20 and cause the controller to repeatedly cause the speaker 23 to emit an audible alarm to alert a user to replace the receptacle top 30 until the top is replaced.

In the illustrated embodiment, the electronics housing 21 includes a display screen 25 which is connected to the controller and is operative to display the amount of time remaining in a given time period (whether open or closed). In some embodiments, the controller may cause a visual alarm to be displayed by the display screen 25 when an audible alarm is generated.

In the preferred embodiment, the electrical port 22 defines a USB port.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A personal cigarette dispensing receptacle for mechanically limiting access to cigarettes, comprising:
a receptacle base having a receptacle top adapted to be moved between a closed configuration and an open configuration relative to the receptacle base, wherein when said receptacle top is in the closed configuration, the receptacle top and the receptacle base combine to form an enclosure;
an electronics housing integral with said receptacle base and having a controller and an internal power source electrically connected to one another; and
a locking mechanism integral with said receptacle base and said receptacle top, wherein said locking mechanism is configured to automatically lock and unlock the receptacle top in the closed configuration on selected time intervals.

2. The personal cigarette dispensing receptacle of claim 1, additionally comprising an electrical port electrically connected to said controller so as to enable electricity introduced to the electrical port to be directed to the controller.

3. The personal cigarette dispensing receptacle of claim 2, wherein said locking mechanism defines an electromagnet integrated with the receptacle base and a ferromagnetic surface integrated with the receptacle top such that when the receptacle top is placed on the receptacle base and electricity from at least one of the power source or electrical port is supplied to the electromagnet, the receptacle top is fixed to the receptacle base.

4. The personal cigarette dispensing receptacle of claim 1, wherein said locking mechanism defines an electromagnet integrated with the receptacle base and a ferromagnetic surface integrated with the receptacle top such that when the receptacle top is placed on the receptacle base and electricity is supplied to the electromagnet, the receptacle top is fixed to the receptacle base.

5. The personal cigarette dispensing receptacle of claim 1, additionally comprising a speaker integral with the receptacle base and electrically connected to said controller so as to enable the controller to cause the broadcast of an audible alert over the speaker.

6. The personal cigarette dispensing receptacle of claim 1, additionally comprising a display screen integral with the receptacle base and electrically connected to said controller so as to enable the controller to cause the display of a visual alert on the display screen.

7. A personal cigarette dispensing receptacle for mechanically limiting access to cigarettes, comprising:
a receptacle base having a receptacle top adapted to be moved between a closed configuration and an open configuration relative to the receptacle base, wherein when said receptacle top is in the closed configuration, the receptacle top and the receptacle base combine to form an enclosure;
an electronics housing integral with said receptacle base and having a controller and an internal power source electrically connected to one another;
an electrical port electrically connected to said controller so as to enable electricity introduced to the electrical port to be directed to the controller;
a locking mechanism integral with said receptacle base and said receptacle top, wherein said locking mechanism defines an electromagnet integrated with the receptacle base and a ferromagnetic surface integrated with the receptacle top such that when the receptacle top is in the closed configuration and electricity is supplied to the electromagnet, the receptacle top is fixed to the receptacle base; and
said locking mechanism configured to automatically lock and unlock the receptacle top in place on the receptacle base on selected time intervals.

8. The personal cigarette dispensing receptacle of claim 7, additionally comprising a speaker integral with the receptacle base and electrically connected to said controller so as to enable the controller to cause the broadcast of an audible alert over the speaker.

9. The personal cigarette dispensing receptacle of claim 8, additionally comprising a display screen integral with the receptacle base and electrically connected to said controller so as to enable the controller to cause the display of a visual alert on the display screen.

10. The personal cigarette dispensing receptacle of claim 7, additionally comprising a display screen integral with the receptacle base and electrically connected to said controller so as to enable the controller to cause the display of a visual alert on the display screen.
